(19) United States
(12) Patent Application Publication
(10) Pub. No.: US 2015/0142685 A1
(43) Pub. Date: May 21, 2015

(54) METHODS AND APPARATUS HAVING APPLICABILITY TO EVALUATION OF HIRING CANDIDATES

(71) Applicant: Saba Software, Inc., Redwood Shores, CA (US)

(72) Inventors: Bernard P. Willis, San Francisco, CA (US); Hemanth Puttaswamy, Fremont, CA (US); Charles Hammel, Austin, TX (US)

(21) Appl. No.: 14/082,175

(22) Filed: Nov. 17, 2013

(51) Int. Cl. G06Q 10/10

(52) U.S. Cl. CPC G06Q 10/1053
USPC 705/321

(57) ABSTRACT

Methods and apparatus having applicability to evaluation of hiring candidates. A method having applicability to evaluation of hiring candidates may include determining a first score for a first attribute of a hiring candidate and a second score for a second attribute of the hiring candidate, assigning the hiring candidate to a recruiting category based, at least in part, on the first and second scores, and controlling a display device to display an indicator associated with the hiring candidate, wherein a property of the indicator is based, at least in part, on the recruiting category to which the hiring candidate is assigned.

### BACKGROUND

Corporations, companies, business organizations, or other entities (hereafter referred to as “employers”) who hire significant numbers of employees typically require a system of some sort to manage those employees. Often this service is performed by a Human Resources (HR) department of the employer entity, which is charged with ensuring that the employer is sufficiently staffed to efficiently conduct its business on a day-to-day basis. This may involve hiring employees, establishing and disbursing appropriate compensation and benefits, conducting performance reviews, monitoring employee absences and withdrawals, and terminating employees as necessary. Typically these HR tasks are performed by personnel who bring their human experience and training to bear on monitoring employees and taking necessary actions to ensure that the employer is efficiently and consistently staffed. As used herein, the term “employee” refers to a person working for an employer entity, and the set of services the person is expected to provide to the entity as part of the person's employment is referred to as the person's “job.”

Hiring employees is an important function of the typical HR department of an employer entity. The process of hiring an employee typically involves reviewing resumes of candidates for employment (hereinafter referred to as “hiring candidates”), interviewing the hiring candidates, reviewing evaluations of the hiring candidates (e.g., evaluations prepared by interviewers), deciding which hiring candidate(s) is/are most suitable for employment, and/or negotiating with one or more hiring candidates deemed suitable for employment. An employee who interviews a hiring candidate typically provides a narrative evaluation of the hiring candidate's suitability for employment. Often, interviewers subjectively rate the hiring candidates, e.g., “strong” or “weak,” on characteristics such as “experience” or “skills” In some embodiments, an interviewer's rating of a candidate may be represented as a value on a scale, such as a scale from one to five (e.g., a scale from one star to five stars). These interviewer evaluations and/or ratings are typically used to determine whether to extend a job offer to a hiring candidate, the amount of compensation to offer when extending a job offer to a hiring candidate, etc.

### SUMMARY

Some embodiments are directed to a method comprising: using computer-encoded data representing scores associated with a hiring candidate, determining a first score for a first attribute of the hiring candidate and a second score for a second attribute of the hiring candidate; using one or more processing circuits, assigning the hiring candidate to a recruiting category based, at least in part, on the first and second scores; and controlling a display device to display an indicator associated with the hiring candidate, wherein a property of the indicator is based, at least in part, on the recruiting category to which the hiring candidate is assigned.

Some embodiments are directed to an apparatus comprising: at least one processing circuit; and at least one storage medium storing instructions that, when executed by the at least one processing circuit, cause the at least one processing circuit to: determine a first score and a second score for respective first and second attributes of a hiring candidate based, at least in part, on scores associated with the hiring candidate, assign the hiring candidate to a recruiting category based, at least in part, on the first and second scores, and control a display device to display an indicator associated with the hiring candidate, wherein a property of the indicator is based, at least in part, on the recruiting category to which the hiring candidate is assigned.

Some embodiments are directed to at least one computer-readable storage medium encoded with computer-executable instructions that, when executed, perform a method comprising: using computer-encoded data representing scores associated with a hiring candidate, determining a first score for a first attribute of the hiring candidate and a second score for a second attribute of the hiring candidate; using one or more processing circuits, assigning the hiring candidate to a recruiting category based, at least in part, on the first and second scores; and controlling a display device to display an indicator associated with the hiring candidate, wherein a property of the indicator is based, at least in part, on the recruiting category to which the hiring candidate is assigned.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart of a method for evaluation of hiring candidates, in accordance with some embodiments;

FIG. 2 is a schematic of a user interface 100 for evaluation of hiring candidates, in accordance with some embodiments;

FIG. 3 is a schematic of a candidate indicator 400, in accordance with some embodiments;

FIG. 4 is a schematic of a user interface 200 for evaluation of hiring candidates, in accordance with some embodiments;

FIG. 5 is a schematic of a user interface 300 for evaluation of hiring candidates, in accordance with some embodiments;

FIG. 6 is a schematic of a user interface 500 for evaluation of hiring candidates, in accordance with some embodiments; and

FIG. 7 is a block diagram illustrating an exemplary computer system on which aspects of the present disclosure may be implemented.

### DETAILED DESCRIPTION

The inventors have appreciated that conventional methods of evaluating candidates for hiring have become increasingly inadequate in a competitive economy. Some conventional hiring processes require managers to devote excessive time and effort to the evaluation of hiring candidates. Such hiring processes may be slow (e.g., if a manager prioritizes other tasks over the hiring process) or may lead to mismanagement of other resources (e.g., if a manager prioritizes hiring over other tasks). When the hiring process is slow, an employer's competitors may identify and hire a strong hiring candidate before the employer extends an offer to the candidate. Thus, a slow hiring process may have an adverse impact on the employer's ability to hire the best candidates. Furthermore, some conventional hiring processes may be overly subjective, with the evaluation and comparison of hiring candidates depending largely on a manager's instincts and personal tastes, which may lead to poor hiring decisions. Poor hiring decisions may lead to a high rate of attrition among employees and/or poor performance by employees, such that the time and resources invested by the employer to hire and train the new employees are wasted.

Thus, more efficient techniques for evaluating candidates for hiring would be beneficial to many employers. The inventors have recognized and appreciated that the efficiency of hiring processes can be improved by assigning hiring candidates to recruiting categories (sometimes referred to herein as “recruiting boxes” or “boxes”) based on scoring of the candidates' attributes. Grouping sets of candidates (e.g., sets of candidates with similar attributes) into respective recruiting categories may facilitate efficient identification of the best candidates, and may also help to highlight similarities and/or differences among candidates.

The inventors have also recognized and appreciated that the efficiency of hiring processes can be further improved by providing a suitable user interface to a computer system configured to store data relating to the hiring candidates and the recruiting categories, to receive queries relating such data, and to process such data in response to the queries. Based on the computer system's data and data processing, the user interface may display indicators associated with the hiring candidates, wherein one or more properties of a candidate's indicator depend on the recruiting category to which the candidate is assigned. For example, indicators associated with the hiring candidates may be displayed in regions of a graph, with the region of a candidate's indicator being determined based on the recruiting category to which the candidate is assigned. As another example, indicators associated with the hiring candidates may be displayed at positions in a region of a graph, with the position of a candidate's indicator within the corresponding region being determined based on the candidate's attribute scores. As another example, indicators associated with hiring candidates may be displayed in an ordered list, with an indicator's position in the list being based on the recruiting category to which the corresponding hiring candidate is assigned. Such visualization techniques may facilitate efficient identification and comparison of candidates' strengths and weaknesses.

Hiring recommendations may be made based on the recruiting categories to which candidates are assigned. For example, it may be recommended to extend an offer of employment or an offer for a job interview based on a candidate's recruiting category. As another example, an amount of compensation to offer a candidate as part of an offer of employment may be recommended based on the candidate's recruiting category.

The various aspects described above, as well as further aspects, will now be described in detail below. It should be appreciated that these aspects may be used alone, all together, or in any combination of two or more, to the extent that they are not mutually exclusive.

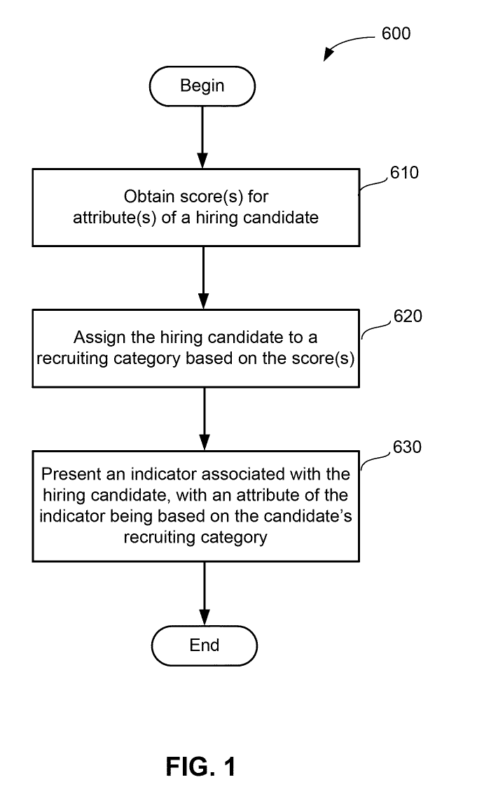

FIG. 1 illustrates a method 600 for evaluation of one or more candidates, in accordance with some embodiments. Method 600 may, for example, be used by an employer to evaluate hiring candidates. At step 610, one or more scores are obtained for one or more attributes of the hiring candidate. The attributes may be attributes of interest to an employer, including, but not limited to, education, experience, professionalism, skills, leadership, potential, cultural fit, job description fit, job qualifications fit, test results, and/or any other suitable attribute. Scores for the candidate's attributes may be obtained using any suitable technique, including, but not limited to, receiving the scores (e.g., from a third party), assigning the scores (e.g., making judgments about the extent to which a candidate possesses an attribute based on information about and/or interaction with the candidate), and/or calculating representative scores based on other scores (e.g., the received scores and/or the assigned scores).

The “education” attribute may represent the quality and/or extent of the candidate's education. The quality and/or extent of the candidate's education may be assessed based on the degrees conferred upon the candidate, the educational institutions the candidate has attended, the candidate's grades, the candidate's vita, the candidate's transcripts, the candidate's social media profile, the candidate's resume, one or more interviews with the candidate, and/or any other suitable source of information about the candidate's education.

The “experience” attribute may represent the quality and/or extent of the candidate's work experience (e.g., general work experience, work experience relevant to a field of interest, and/or work experience relevant to the position for which the candidate is being considered). The quality and/or extent of the candidate's experience may be assessed based on the candidate's resume, the candidate's employment history, the candidate's social media profile, the candidate's references, one or more interviews with the candidate, and/or any other suitable source of information about the candidate's experience.

The “skills” attribute may represent the quality and/or extent of the candidate's skills. In some embodiments, the candidate's skills may include hard skills, soft skills, technical skills, communication skills, management skills, skills relevant to the position for which the candidate is being considered, and/or any other suitable skills. The quality and/or extent of the candidate's skills may be assessed based on the candidate's resume, the candidate's experience, the candidate's social media profile, one or more tests administered to the candidate, one or more interviews with the candidate, a sample work product provided by the candidate, and/or any other suitable source of information about the candidate's skills.

The “leadership” attribute may represent the strength and/or extent of the candidate's leadership qualities (e.g., general leadership qualities and/or qualities that are relevant to providing effective leadership in the position for which the candidate is being considered). The strength and/or extent of the candidate's leadership qualities may be assessed based on the candidate's resume, the candidate's previous leadership experience, one or more tests administered to the candidate, one or more interviews with the candidate, and/or any other suitable source of information about the candidate's leadership abilities.

The “potential” attribute may represent the candidate's potential to be successful (e.g., to be successful as an employee, to be successful as a leader, to successfully perform a task of interest, and/or to be successful in the position for which the candidate is being considered). The candidate's potential may assessed based on the candidate's experience, the candidate's education, one or more interviews with the candidate, one or more tests administered to the candidate, resources available to train the candidate, and/or any other suitable source of information about the candidate's potential.

The “cultural fit” attribute may represent the extent to which the candidate is perceived to be compatible with a culture of the employer (e.g., the employer's general culture and/or the culture of a division, group, or office associated with the position for which the candidate is being considered). The cultural fit between a hiring candidate and an employer may be assessed based on the candidate's personality, the candidate's professional practices, and/or any other suitable attribute. Such attributes may be assessed based on the candidate's reputation, one or more interviews with the candidate, one or more tests administered to the subject, and/or any other suitable source of information about the candidate.

The “job description fit” attribute may represent the extent to which the candidate satisfies one or more criteria associated with a description of the position for which the candidate is being evaluated. The fit between a hiring candidate and a job description may be assessed based on the candidate's resume, the candidate's transcripts, the candidate's social media profile, the candidate's cover letter, and/or any other suitable source of information about the candidate. For example, information obtained from such sources of information about the candidate may be compared to a job description. In some embodiments, this comparison may be performed automatically (e.g., by a computer configured to extract information about the candidate from sources such as the above-described sources, and to determine whether the extracted information satisfies one or more criteria associated with a description of the position for which the candidate is being considered). A “job description fit” may be a type of “pre-assessment score.”

The “job qualification fit” attribute may represent the extent to which the candidate possesses one or more qualifications and/or satisfies one or more criteria associated with the position for which the candidate is being evaluated. The fit between a hiring candidate and the qualifications or criteria associated with a position may be assessed based on the candidate's resume, the candidate's transcripts, the candidate's social media profile, the candidate's cover letter, and/or any other suitable source of information about the candidate. For example, information obtained from such sources of information about the candidate may be compared to a set of qualifications and/or criteria associated with the position for which the candidate is being considered. In some embodiments, this comparison may be performed automatically (e.g., by a computer configured to extract information about the candidate from sources such as the above-described sources, and to determine, based on the extracted information, whether the candidate possesses the qualifications and/or satisfies the criteria associated with the position). As just one example, a candidate's job qualification fit may be determined by a computer programmed to analyze one or more of the above-described sources of information about the candidate (e.g., to extract and/or identify keywords associated with the candidate), and to determine the extent to which the candidate possesses the qualifications and/or satisfies the criteria associated the position (e.g., by comparing the extracted and/or identified keywords to keywords associated with the qualifications and/criteria). A “job qualification fit” may be a type of “pre-assessment score.”

The “test results” attribute may represent a candidate's performance on one or more suitable tests, including, but not limited to, tests of the candidate's knowledge, tests of the candidate's skills, test of the candidate's aptitudes, standardized tests (e.g., the SAT, GRE, LSAT, GMAT, or IQ tests), behavioral tests, psychological tests, written tests, oral tests, physical tests, general tests, and/or tests of attributes specifically associated with the position for which the candidate is being evaluated. In some embodiments, the candidate's performance on a test may be represented by a score. In some embodiments, the candidate's performance (e.g., scores) on multiple tests may be combined, using any suitable technique, to generate a combined “test results” score for the candidate.

In some embodiments, an assessment process may be used to determine a candidate's attributes. Techniques for assessing the candidate may include, but are not limited to, reviewing information about the candidate (e.g., cover letter, resume, transcript, writing sample, social media profile, test results etc.), interviewing the candidate, communicating with the candidate's reference(s), and/or any other suitable technique for evaluating the candidate's attributes.

In some embodiments, assessing a candidate may include assigning one or more scores representing the quality (e.g., nature, extent, degree, and/or strength) of the candidate's attributes. Any suitable scoring system may be used, as some embodiments are not limited in this regard. In some embodiments, an attribute may be associated with a range of possible scores, and the candidate's attribute may be assigned a score within the corresponding range, based on the assessment of the candidate. Examples of suitable score ranges may include, but are not limited to, ranges of zero or one to four, five, or ten. The ranges of suitable scores for different attributes may be the same or different. As just one example, a candidate may be assigned a score on a scale of one to five for each attribute of interest.

In some embodiments, a candidate may be assigned one or more scores by one or more interviewers. For example, a candidate may be interviewed by several people associated with the prospective employer (e.g., several employees of the prospective employer). Based on their impressions of the candidate, the interviewers may assign scores representing the quality of the candidate's attributes. The assigned scores may be entered into a computer system. The computer system may store the candidate's scores, make the candidate's scores available for viewing, provide the candidate's scores in response to queries, and/or process the candidate's scores in any suitable way to facilitate the hiring process.

In some embodiments, a candidate may be assigned multiple scores for the same attribute. Such scores may, for example, correspond to multiple assessments of the candidate. For example, the candidate may be assessed by multiple assessors (e.g., interviewers), and/or the candidate may be assessed using multiple assessment techniques (e.g., interviews, tests, etc.). When a candidate's attribute receives two or more assessment scores, these assessment scores may be processed to determine a summary score for the attribute. The summary score may include, but is not limited to, a mean, median, mode, standard deviation, and/or variance of the assessment scores, and/or any other suitable parameter or statistic derived from the assessment scores or calculated based on the assessment scores. Assessment scores and/or summary scores may be referred to herein as “scores” or “attribute scores.”

At step 620, the candidate is assigned to a recruiting category based, at least in part, on the candidate's attribute scores. A recruiting category may comprise a set of zero or more candidates. In some embodiments, candidates in the same recruiting category may be similar in one or more ways. For example, candidates in the same recruiting category may have similar scores for one or more attributes. Forming groups of similar candidates may facilitate comparison of candidates. For example, grouping similar candidates may facilitate identification of similarities and/or differences among candidates in the same recruiting category, or among candidates in different recruiting categories. Grouping similar candidates may also facilitate the recruiting process. For example, determinations such as whether to extend an offer for an interview, whether to extend a hiring offer, or whether to reject a candidate may be made based, at least in part, on the recruiting category to which the candidate is assigned.

Any suitable technique may be used to assign a candidate to a recruiting category based, at least in part, on the candidate's attribute scores. In some embodiments, the assignment may be based on the candidate's assessment scores (e.g., all of the assessment scores, or a subset of the assessment scores), on the candidate's summary scores (e.g., all of the summary scores, or a subset of the summary scores), and/or on parameters determined based, at least in part, on one or more of the candidate's attribute scores (e.g., calculated using one or more attribute scores, or derived from one or more attribute scores). In some embodiments, a parameter or score may include a “nearest” value of an attribute score, such as a value obtained by rounding a score, calculating the ceiling of a score, or calculating the floor of a score. In some embodiments, a parameter may be calculated as a function of one or more scores, which may correspond to one or more attributes.

In some embodiments, a recruiting category may be associated with one or more criteria, and a candidate may be assigned to the recruiting category if the candidate's scores and/or parameters satisfy at least one of the criteria, one or more subsets of the criteria, or all the criteria. Examples of suitable criteria may include, but are not limited to, a candidate's attribute score falling within a corresponding range of scores for that attribute, a candidate's attribute score being less than or greater than a corresponding threshold score for that attribute, a candidate's parameter value falling within a corresponding range of parameter values, a candidate's parameter value being less than or greater than a corresponding threshold value, and/or any other suitable criterion.

The assignment of a candidate to a recruiting category may be performed by a computer system. The computer system may be configured (e.g., may include a processor programmed) to identify a recruiting category having one or more criteria that are met by the candidate. In some embodiments, the computer system may represent the one or more criteria associated with a recruiting category as one or more comparisons and/or conditional expressions having results which depend, at least in part, on the candidate's attribute scores and/or parameter values. By performing the comparison(s) and/or evaluating the conditional expression(s), the computer system may determine whether the candidate satisfies the one or more criteria associated with a recruiting category. In some embodiments, the computer system may query a database of candidates' attribute scores and/or parameter values to obtain the data needed to perform the comparisons or evaluate the conditional expressions. In some embodiments, the computer system may load a candidate's attribute scores and/or parameter values from a data structure or data store configured to store the attribute scores and/or parameter values of one or more candidates. As just one example, a recruiting category may be associated with a nearest value of “4” for the “experience” attribute and a nearest value of “5” for the “potential” attribute. Any candidate with a nearest value of “4” for the “experience” attribute and a nearest value of “5” for the potential attribute may be assigned to the recruiting category. In some embodiments, assignment of a candidate to a recruiting category may depend on the candidate's scores for one, two, three, or more attributes.

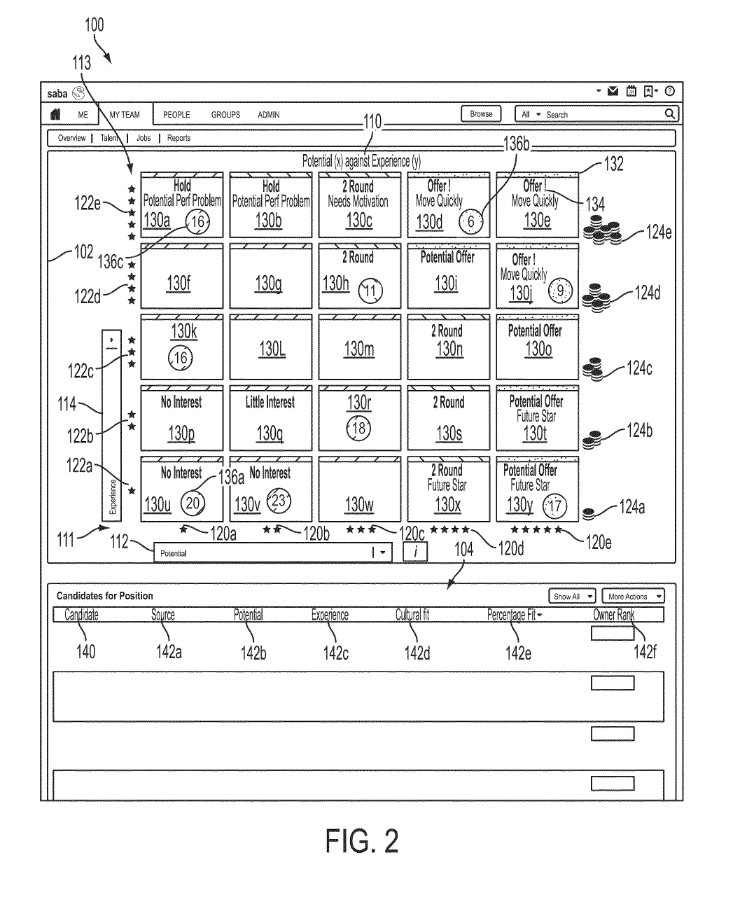

Any suitable number of recruiting categories may be used to classify the candidates, as embodiments are not limited in this regard. In some embodiments, the number of recruiting categories may be between 2 and 100, between 2 and 50, between 2 and 25, between 4 and 25, between 5 and 25, between 10 and 25, between 15 and 25, between 20 and 25, or exactly 25. In some embodiments, the recruiting categories may be mutually exclusive, such that a candidate cannot satisfy the criteria associated with more than one recruiting category. FIG. 2 illustrates an example in which candidates may be assigned to 25 recruiting categories based on their scores for the “experience” attribute and the “potential” attribute. The example of FIG. 2 is discussed in more detail below. At step 630, an indicator associated with the hiring candidate is presented (e.g., displayed). In some embodiments, at least one property of the indicator is based on the recruiting category to which the candidate is assigned. In some embodiments, presenting an indicator may comprise causing a device, including, but not limited to, an audio speaker and/or a video display, to audibly or visibly present the indicator. Audibly presenting the indicator may comprise playing recorded sounds and/or synthesizing sounds, including, but not limited to, music or speech. Visibly presenting the indicator may comprise displaying the indicator. Embodiments of indicators and techniques for presenting indicators are described below with reference to FIGS. 2-6.

FIG. 2 illustrates a user interface 100 of a system for evaluation of hiring candidates, according to some embodiments. User interface 100 includes a candidate graph 102 and a candidate list 104. Candidate graph 102 may facilitate evaluation of hiring candidates by graphically summarizing information about the candidate's attributes. As can be seen, candidate graph 102 may include candidate indicators 136 and/or recruiting category indicators 130, which may be organized in a graph area. The graph area may have one axis, two axes (e.g., horizontal axis 111 and vertical axis 113), three axes, or any other suitable number of axes.

Each axis may represent one or more attributes or parameters associated with hiring candidates. In the example of FIG. 2, horizontal axis 111 represents a candidate's “potential,” and vertical axis 113 represents a candidate's “experience.” In some embodiments, an axis of candidate graph 102 may represent any suitable candidate attribute, including, but not limited to, the attributes described above. In some embodiments, an axis of candidate graph 102 may represent a parameter determined based, at least in part, on one or more candidate attributes.

Candidate graph 102 may be configured to permit a user to associate an attribute or parameter with an axis of the graph. In some embodiments, candidate graph 102 may include axis control interfaces associated with the graph's axes. In the example of FIG. 2, axis control interface 112 may be used to select an attribute or parameter represented by first axis 111, and axis control interface 114 may be used to select an attribute or parameter represented by second axis 113. An axis control interface may be implemented using one or more drop down boxes, checkboxes, selection boxes, and/or any other interface or technique suitable for specifying an attribute or parameter.

The range of values associated with an axis may cover any suitable range and may be represented using any suitable technique and/or indicator. In the example of FIG. 2, the values associated with first axis 111 range from “one” (represented by one star 120a) to “five” (represented by five stars 120e), and the values associated with second axis 113 range from “one” (represented by one star 122a) to “five” (represented by five stars 122e). In some embodiments, the range of values associated with an axis may be discrete or continuous. In some embodiments, the values associated with an axis may be represented by numbers, symbols, alphanumeric characters, images, and/or any other suitable indicators. In some embodiments, different axes may have the same ranges of associated values or different ranges of associated values.

In some embodiments, candidate graph 102 may include one or more recruiting category indicators 130 corresponding to one or more recruiting categories. In the example of FIG. 2, candidate graph 102 includes twenty-five recruiting categories. Each of the twenty-five recruiting categories of FIG. 2 may correspond to a combination of (1) one of five nearest values for the “potential” attribute associated with the horizontal axis 111, and (2) one of five nearest values for the “experience” attribute associated with the vertical axis 113. For example, as illustrated in FIG. 2, twenty candidates with a nearest “potential” value of approximately “one” and a nearest “experience” value of approximately “one” may be assigned to recruiting category 130u, which may be located near coordinate (1, 1) of the graph area.

A recruiting category indicator 130 may indicate (e.g., show, represent, and/or suggest) information relating to the corresponding recruiting category. Such information may be indicated using words, letters, numbers, alphanumeric characters, symbols, images, colors, properties of colors, patterns, fonts, text effects, and/or any other medium suitable for communicating information. As can be seen, a recruiting category indicator 130 may include an interest level indicator 132, a recruiting category recommendation item 134, and/or a candidate indicator 136.

In some embodiments, interest level indicator 132 may indicate a recommended level of interest (e.g., employer interest) in the candidates assigned to the corresponding recruiting category, and/or a tier of one or more recruiting categories to which the corresponding recruiting category belongs. Such information may be indicated using any medium suitable for communicating information.

In some embodiments, the information communicated via user interface 100 (e.g., via interest level indicator 132 and/or candidate indicator 136) may be communicated using one or more colors and/or one or more color properties (e.g., hue, tint, shade, tone, saturation, lightness, chromaticity, intensity, luminance, grayscale, etc.). For example, recruiting category indicators corresponding to recruiting categories in a same tier may include an interest level indicator 132 with a same color. Likewise, candidate indicators 136 corresponding to candidates in a same tier may include a same color. Among a group of recruiting category indicators having interest level indicators 132 with a same color, different recruiting category indicators may have different color properties (e.g., shades). Likewise, among a group of candidate indicators 136 with a same color, different recruiting category indicators may have different color properties. In some embodiments, the differences in color property (e.g., shading) may indicate differences in the recommended interest levels for the respective recruiting categories (and/or candidates).

In some embodiments, the system may make a recommendation regarding a hiring candidate based, at least in part, on the tier and/or interest level to which the candidate's recruiting category is assigned. For example, based on the recruiting category's tier and/or interest level, the system may recommend that a candidate assigned to the recruiting category be rejected, interviewed, extended a hiring offer, extended a hiring offer with a particular amount of compensation, and/or extended a hiring offer within a particular time frame.

The relationships between recruiting categories and tiers and/or interest levels may be static or dynamic. In some embodiments, a recruiting category may be assigned to a tier and/or interest level based on empirical or historical evidence that the employer's interests are served by following the hiring policies (e.g., recommendations) associated with the tier and/or interest level for candidates who meet the criteria associated with the recruiting category. In some embodiments, the assignment of a recruiting category to a tier and/or interest level may depend, at least in part, on the number of candidates assigned to the various recruiting categories. For example, if the system would typically assign four recruiting categories to a top tier and/or interest level, but the number of candidates in the four recruiting categories exceeds a threshold, the system may assign only two of the recruiting categories to the top tier and/or interest level, while assigning the other two recruiting categories to a lower tier and/or interest level.

In the example of FIG. 2, the interest level indicators 132 of recruiting category indicators 130d, 130e, 130i, 130j, 130o, 130t, and 130y may include a same color (e.g., green), indicating a top tier of recommended employer interest in hiring candidates assigned to the corresponding categories. At least some of interest level indicators of the recruiting categories in this tier may be shaded differently. For example, the color included in interest level indicator 132 of recruiting category indicator 130e may be more darkly shaded than the color included in interest level indicator 132 of recruiting category indicator 130i, indicating a higher level of recommended interest in the candidates assigned to recruiting category 130e than in the candidates assigned to recruiting category 130i. Likewise, the interest level indicators 132 of recruiting category indicators 130b, 130c, 130h, 130n, 130s, and 130x may include a same color (e.g., yellow), indicating a middle tier of recommended employer interest in hiring candidates assigned to the corresponding recruiting categories. The interest level indicators 132 of the remaining recruiting category indicators may include a same color (e.g., red), indicating a lowest tier (or no tier) of recommended employer interest in hiring candidates assigned to the corresponding recruiting categories.

Embodiments are not limited by the number of tiers and/or interest levels into which the recruiting categories may be divided. As can be seen in FIG. 2, the recruiting categories may be divided into three tiers. In some embodiments, the number of tiers may be two, three, three to five, or more than five. In some embodiments, interest level indicator 132 may be optional. In some embodiments, the recruiting categories may not be divided into any tiers and/or interest levels.

Embodiments are not limited by the area of recruiting category indicator 130 occupied by interest level indicator 132. As can be seen in FIG. 2, the interest level indicator 132 may occupy an area along the top edge of a recruiting category indicator 130. In some embodiments, interest level indicator 132 may occupy any suitable area of recruiting category indicator 130, including, but not limited to, an area along one or more peripheral edges of recruiting category indicator 130. In some embodiments, interest level indicator 132 may include any portion of the background of category indicator 130, the entire background of category indicator 130, a font color or font style of any text included in category indicator 130, etc.

In some embodiments, recruiting category indicator 130 may include a recruiting category recommendation item 134, which may indicate a recruiting recommendation for the candidates assigned to the recruiting category. As described above, suitable recommendations may include a recommendation that a candidate assigned to the recruiting category be rejected, interviewed (e.g., extended an offer for a first interview or a subsequent interview), extended a hiring offer, extended a hiring offer with a particular amount of compensation, and/or extended a hiring offer within a particular time frame. Recruiting category recommendation item 134 may indicate the recommendation using words, letters, numbers, alphanumeric characters, symbols, images, and/or any other medium suitable for communicating information.

In some embodiments, recruiting category indicator 130 may include one or more candidate indicators 136. In some embodiments, a candidate indicator 136 may indicate information identifying and/or characterizing one or more candidates. In some embodiments, information identifying and/or characterizing one or more candidates may include information indicating how many candidates are assigned to a corresponding recruiting category. In the example of FIG. 2, candidate indicator 136a indicates that 20 candidates are assigned to recruiting category 130u, and candidate indicator 136b indicates that 6 candidates are assigned to recruiting category 130d. In some embodiments, information identifying and/or characterizing one or more candidates may include information identifying the candidate (e.g., an image of the candidate, information indicating the candidate's name, etc.), the date on which a candidate applied for a position, one or more dates on which the candidate was contacted (e.g., the first date on which the candidate was contacted, the most recent date on which the candidate was contacted, etc.), one or more of the candidate's attribute scores, a source through which the candidate was identified as a hiring candidate (e.g., a social media platform, a headhunter, a recruiting event, communication initiated by the candidate, etc.), the candidate's contact information (e.g., email address, home phone number, work phone number, mobile phone number, mailing address, place of residence, etc.), the candidate's skills, the candidate's current employer, and/or any other information suitable for identifying and/or characterizing a candidate. Candidate indicator 136 may indicate such information using words, letters, numbers, alphanumeric characters, symbols, images, colors, and/or any other medium suitable for communicating information. In some embodiments, such information may be indicated by a position of a candidate indicator 136 within candidate graph 102.

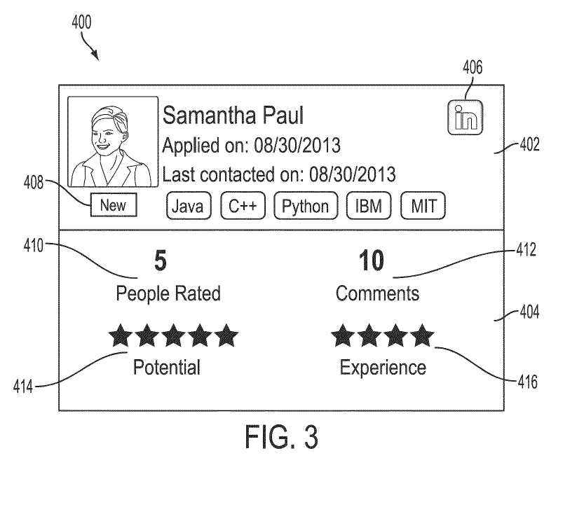

FIG. 3 illustrates an example of a candidate indicator 400, in accordance with some embodiments. As can be seen in FIG. 3, some embodiments of candidate indicator 400 may include a first portion 402 and a second portion 404. The first portion 402 may indicate, for example, biographical information about the candidate. The second portion may indicate, for example, evaluation information about the candidate (e.g., values of the candidate's attributes or parameters, comments about the candidate, etc.). In the example of FIG. 3, first portion 402 of candidate indicator 400 includes an image of a candidate, text indicating the candidate's name, the date on which the candidate applied for a position, and the date on which the candidate was most recently contacted, icons indicating the candidate's skills (e.g., Java, C++, Python, IBM), an icon indicating the candidate's an aspect of the candidate's education, such as an educational institution from which the candidate earned a degree (e.g., MIT), an icon 406 indicating the source through which the candidate was identified as a hiring candidate, and an icon 408 indicating a status of the candidate's application.

In the example of FIG. 3, second portion 402 of candidate indicator 400 includes text 410 indicating how many assessors have provided assessments of the candidate, text 412 indicating how many comments relating to the candidate are available in the system, an icon 414 indicating the candidate's score for a first attribute (“potential” in the example of FIG. 3) and an icon 416 indicating the candidate's score for a second attribute (“experience” in the example of FIG. 3).

In some embodiments, one or more properties of a candidate indicator 136 may be based, at least in part, on the recruiting category to which the corresponding candidate(s) is/are assigned. In some embodiments, a recruiting candidate indicator 136 may indicate how many candidates are assigned to the corresponding recruiting category. In some embodiments, the position of a recruiting category indicator 136 within candidate graph 102 may depend on the recruiting category to which the corresponding candidate(s) is/are assigned. For example, as illustrated in FIG. 2, a candidate indicator 136 may be co-located with (e.g., positioned within, on, or adjacent to) the corresponding recruiting category indicator 130. Thus, the position of a candidate indicator 136 within candidate graph 102 (e.g., relative to the axes of the candidate graph) may indicate approximate values of one or more of the candidate's attribute scores or parameters, since the position of recruiting category indicator 130 co-located with the candidate indicator 136 may indicate approximate values of attribute scores or parameters associated with the recruiting category.

In some embodiments, one or more properties of a candidate indicator 136 may be based, at least in part, on one or more attribute scores and/or parameters of the corresponding candidate. In some embodiments, the position of a candidate indicator 136 within candidate graph 102 may depend on the corresponding candidate's attribute scores and/or parameters. In some embodiments, the position of a candidate indicator 136 within (or relative to) a corresponding recruiting category indicator 130 may depend on the corresponding candidate's attribute scores and/or parameters. For example, as the score and/or parameter values of a candidate increase, the position of corresponding candidate indicator 136 may generally move in one or more directions relative to corresponding recruiting category indicator 136 (e.g., in the directions of increasing values along the graph's axes). Likewise, as the score and/or parameter values of a candidate decrease, the position of corresponding candidate indicator 136 may generally move in one or more directions relative to corresponding recruiting category indicator 130 (e.g., in the directions of decreasing values along the graph's axes). Thus, the position of a candidate indicator 136 within a candidate graph 102 (e.g., relative to the axes of the candidate graph) and/or relative to a corresponding recruiting category indicator 130 may indicate values of one or more of the candidate's attribute scores or parameters.

In some embodiments, a candidate indicator 136 may include an interest level indicator. In the examples of FIGS. 2, 4 and 6, a recommended level of interest in a candidate or group of candidates may be indicated by an interest level indicator (e.g., color) associated with a candidate indicator or a portion thereof.

In some embodiments, candidate graph 102 may include one or more candidate indicators 136 without including recruiting category indicators 130. In such embodiments, regions of candidate graph 102 may be associated with respective recruiting categories. For example, the region of candidate graph 102 at coordinate (X, Y) may be associated with a recruiting category that includes candidates having a nearest value of X for the attribute associated with horizontal axis 111, and a nearest value of Y for the attribute associated with vertical axis 113, even if no recruiting category indicator is displayed at coordinate (X, Y). In such embodiments, one or more properties of a candidate indicator 136 may depend on the recruiting category to which the corresponding candidate(s) is/are assigned, as described above, even though a recruiting category indicator 130 corresponding to the recruiting category is not shown.

In some embodiments, recruiting category indicators 130 of candidate graph 102 may be organized in a grid, as illustrated in the example of FIG. 2. In some embodiments, there may be substantial separation between adjacent recruiting category indicators (e.g., the grid lines or other features separating the recruiting category indicators may have a non-negligible thickness. In some embodiments, there may be insubstantial separation or no separation between adjacent recruiting category indicators (e.g., the grid lines or other features separating the recruiting category indicators may have a negligible thickness, or there may be no grid lines or other features separating the recruiting category indicators from each other).

In some embodiments, candidate graph 102 may include one or more recommendation indicators 124. A recommendation indicator 124 may indicate a hiring recommendation for one or more recruiting categories and/or candidates, including, but not limited to, the recruiting categories and/or candidates corresponding to the recruiting category indicators 130 and/or candidate indicators 136 disposed in a row adjacent to the recommendation item 124, the recruiting categories and/or candidates corresponding to the recruiting category indicators 130 and/or candidate indicators 136 disposed nearest to the recommendation item 124, or any other suitable set of recruiting categories and/or candidates. For example, recommendation indicator 124e may indicate a recommendation applicable to candidates and/or recruiting categories corresponding to recruiting category indicators 130a-130e and/or candidate indicators 136b-136c, which are disposed in the row adjacent to recommendation item 124e. As another example, recommendation item 124e may indicate a recommendation applicable to candidates and/or recruiting categories corresponding to recruiting category indicator 130e, because recommendation item 124e is disposed nearer to recruiting category indicator 130e than to any other recruiting category indicator.

In some embodiments, recommendation indicator 124 may indicate a recommended amount of compensation to be offered to candidates who are associated with the recommendation indicator and to whom hiring offers are extended. In some embodiments, the recommended amount of compensation may depend, at least in part, on the value of the candidate's “experience” attribute. In some embodiments, the recommended amount of compensation may be determined by selecting a sub-range of a permissible salary range. The permissible salary range may be provided by an operator of user interface 100. The sub-range may depend on the value of the candidate's experience attribute. As just on example, if the permissible salary range for a position is $40,000 to $60,000, and the range of values for the “experience” attribute is 1 to 5, the permissible salary range may be segmented into five sub-ranges (e.g., $40K-$44K for candidates with experience value nearest 1, $44K-$48K for candidates with experience value nearest 2, $48K-$52K for candidates with experience value nearest 3, $52K-$56K for candidates with experience value nearest 4, and $56K-$60K for candidates with experience value nearest 5). In some embodiments, the salary sub-ranges may overlap at least in part.

In some embodiments, candidate graph 102 may include a title indicator 110. Title indicator 110 may indicate information summarizing one or more aspects of candidate graph 102. In some embodiments, title indicator 110 may indicate which attributes are associated with the axes of the graph. In some embodiments, title indicator 110 may indicate a position for which candidates (e.g., candidates corresponding to candidate indicators 136 and/or the candidates included in the recruiting categories corresponding to recruiting category indicators 130) are being considered.

In some embodiments, user interface 100 includes a candidate list 104. Candidate list 104 may include a list of candidates, including, but not limited to, a list of candidates for one or more positions, a list of candidates assigned to one or more specified tiers, interest levels, and/or recruiting categories, a list of candidates to whom hiring offers have been extended, a list of candidates who have been invited to interview for a position, a list of candidates who have been interviewed (e.g., for a specified position), a list of candidates with attribute scores and/or parameter values that satisfy specified criteria, and/or any other suitable list of candidates.

In some embodiments, candidate list 104 may include candidate indicators corresponding to the candidates in the list. In some embodiments, candidate list 104 may be organized in rows, with each row of candidate list 104 including a candidate indicator.

In some embodiments, candidate list 104 may be organized in rows and columns. In some embodiments, the rows may correspond to candidates and the columns may correspond to types of information associated with the candidates, or vice versa. In the example of FIG. 2, the rows of candidate list 104 correspond to candidates, and the columns of candidate list 104 correspond to types of information associated with the candidates. Specifically, candidate list 104 includes a column 140 for information identifying a candidate and the candidate's place of residence, columns 142a-142e for information indicating a candidate's scores for various attributes, and a column 142f indicating a candidate's ranking. The candidates' rankings may indicate, for example, the relative suitability of the candidates for a position, with the highest-ranked candidate being the most suitable and the lowest-ranked candidate being the least suitable. In some embodiments, the rankings may be assigned automatically, based, at least in part, on the recruiting categories to which the candidates are assigned and/or on the candidates' attribute scores. In some embodiments, the rankings may be assigned by an employer, an agent of an employer, an assessor of the candidates, and/or any other suitable entity or technique. In some embodiments, column 142f may include an input interface for assigning a ranking to a candidate.

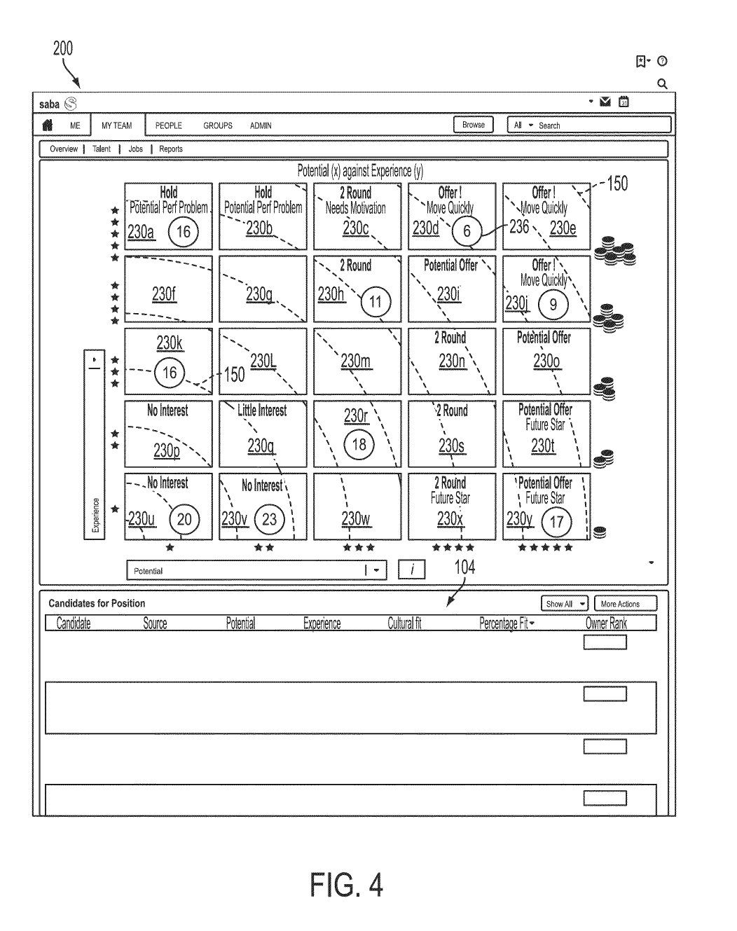

FIG. 4 illustrates a user interface 200 of a system for evaluation of hiring candidates, according to some embodiments. User interface 200 includes a candidate graph 202. In some embodiments, candidate graph 202 may include one or more recruiting category indicators 230 and/or one or more candidate indicators 236.

In some embodiments, candidate graph 202 may use one or more colors and/or color properties to indicate a tier to which a recruiting category and/or candidate is assigned, and/or to indicate an interest level in a recruiting category and/or candidate. As just one example, the colors and/or color properties of the recruiting category indicators 230 and/or candidate indicators 236 may be assigned such that the colors and/or color properties represent a heat map. In some embodiments, the heat map may include concentric rings 150 such that the portions of indicators (230, 236) which coincide with a concentric ring have the same or similar color(s) and/or color properties. In the heat map, recruiting category indicators 230 and/or candidate indicators 236 assigned the same color or similar colors may correspond to recruiting categories and/or candidates for which the recommended recruiting actions are the same or similar. In a heat map region which includes primarily the same color, different portions of the heat map region may have different color properties (e.g., different shades). In some embodiments, the differences in color properties may indicate differences in the recommended interest levels for the corresponding recruiting categories.

In the example of FIG. 4, recruiting category indicators 230d, 230e, 230i, 230j, 230o, 230t, and 230y may include primarily a first color (e.g., green), indicating a top tier of recommended employer interest in hiring candidates assigned to the corresponding recruiting categories. At least some recruiting category indicators of the first color may have different properties (e.g., different shading). For example, the color of recruiting category indicator 230e may be more darkly shaded than the color of recruiting category indicator 230i, indicating a higher level of recommended interest in the candidates assigned to recruiting category 230e than in the candidates assigned to recruiting category 230i. Likewise, recruiting category indicators 230b, 230c, 230h, 230n, 230s, and 230x may include primarily a second color (e.g., yellow), indicating a middle tier of recommended employer interest in hiring candidates assigned to the corresponding recruiting categories. The colors of the remaining recruiting category indicators may include primarily a third or fourth color (e.g., red or orange), indicating a lowest tier (or no tier) of recommended employer interest in hiring candidates assigned to the corresponding recruiting categories.

In some embodiments, candidate graph 202 may include one or more candidate indicators without including recruiting category indicators. In such embodiments, regions of candidate graph 202 may be associated with respective recruiting categories. In such embodiments, candidate graph 202 may use one or more colors and/or color properties to indicate a tier to which a candidate is assigned and/or an interest level in the candidate. The colors and/or color properties may be included in the regions of candidate graph 202 associated with the recruiting categories, and/or included in the candidate indicators.

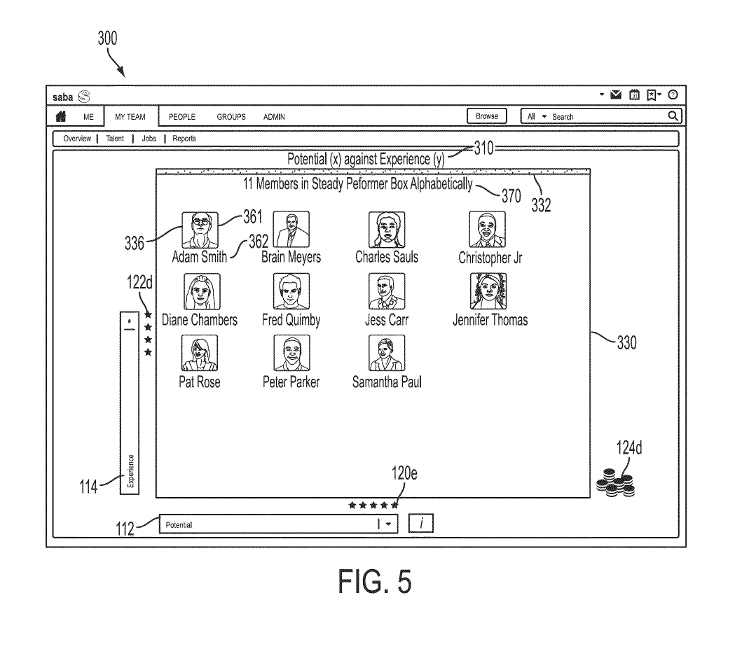

FIG. 5 illustrates a user interface 300 of a system for evaluation of hiring candidates, in accordance with some embodiments. Interface 300 may include a recruiting category indicator 330 corresponding to a recruiting category R. Recruiting category indicator 330 may be displayed in response to selection, in a user interface (e.g., user interface 100, 200, or 500), of a recruiting category indicator corresponding to the recruiting category R, in response to selection, in a user interface, of a candidate indicator corresponding to the recruiting category R, in response to selection or provision of one or more criteria (e.g., ranges or thresholds for attribute scores and/or parameters) corresponding to the recruiting category R, and/or in response to any other suitable event.

In some embodiments, recruiting category indicator 330 may include one or more candidate indicators 336 corresponding to the one or more respective candidates assigned to the recruiting category R. Some embodiments of candidate indicators are described above. In the example of FIG. 5, candidate indicator 336 may include an image 361 of the corresponding candidate and/or text 362 identifying the corresponding candidate (e.g., text showing the candidate's name). In some embodiments, the candidate indicators may be organized alphabetically, positioned within recruiting category indicator 330 based, at least in part, on the candidates' attribute scores and/or parameter values, arranged in an order corresponding to the candidates' rankings, or arranged according to any other suitable criteria.

In some embodiments, recruiting category indicator 330 may include a title indicator 370. In some embodiments, title indicator 370 may indicate a title of recruiting category R, a recruiting recommendation for the candidates assigned to recruiting category R, or any other suitable information. Title indicator 370 may indicate such information using words, letters, numbers, alphanumeric characters, symbols, images, and/or any other medium suitable for communicating information.

In some embodiments, recruiting category indicator 330 may include an interest level indicator 332. Some embodiments of interest level indicators are described above.

In some embodiments, interface 300 may include a title 310. Some embodiments of user interface titles are described above.

In some embodiments, interface 300 may include a recommendation indicator 124 associated with recruiting category R. Some embodiments of recommendation indicators are described above.

In some embodiments, interface 300 may include one or more axis control interfaces (112, 114). Some embodiments of axis control indicators are described above.

In some embodiments, interface 300 may include indicators (120, 122) of the range of attribute scores and/or parameter values associated with recruiting category R. In the example of FIG. 5, recruiting category R may be associated with a nearest “potential” value of “five” (represented by five stars 120e) and a nearest “experience” value of “4” (represented by four stars 122d).

In some embodiments, user interface 300 may include a candidate list 104. Some embodiments of candidate lists are described above.

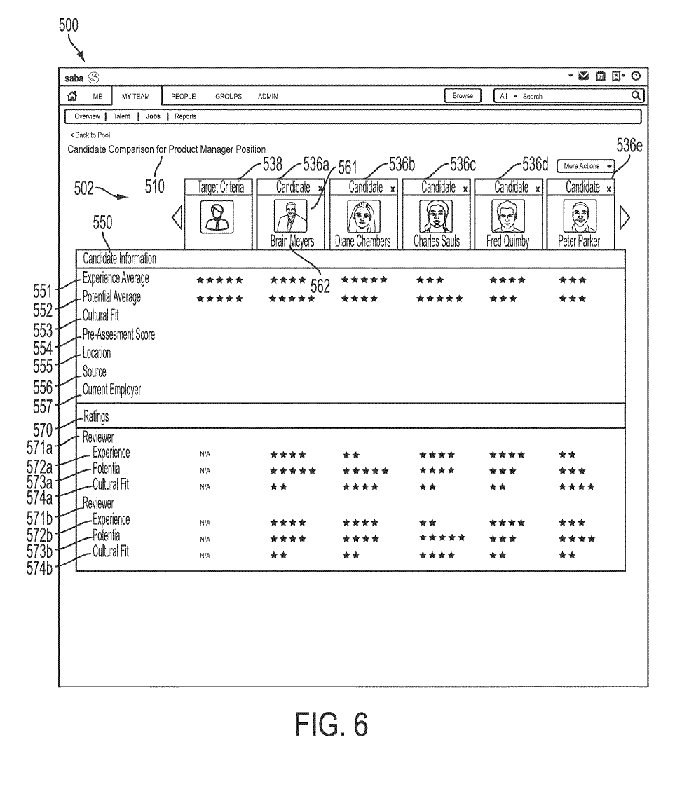

FIG. 6 illustrates a user interface 500 of a system for evaluation of hiring candidates, in accordance with some embodiments. User interface 500 may include a candidate portion 502 and a reviewer portion 570. Candidate portion 502 may include one or more candidate indicators 536. In some embodiments, one or more properties of a candidate indicator 536 may be based, at least in part, on the recruiting category to which the corresponding candidate is assigned. For example, the positions of candidate indicators 536 (e.g., the order in which candidate indicators 536 are arranged) may depend on the recruiting categories to which the candidates are assigned.

In some embodiments, the recruiting categories to which the candidates are assigned may be ranked. The ranking associated with a recruiting category may be determined using any suitable information, including, but not limited to, the employer's satisfaction with previous candidates who were hired after being assigned to the recruiting category, the performance of previous candidates who were hired after being assigned to the recruiting category, the attribute scores and/or parameter values associated with the recruiting category, and/or any other suitable information. In the example of FIG. 2, the recruiting categories corresponding to the recruiting category indicators 130 may be ranked in the following order, from highest (best) ranking to lowest (worst) ranking: (1) 130e, (2), 130j, (3) 130d, (4) 130o, (5) 130t, (6) 130y, (7) 130i, (8) 130n, (9) 130s, (10) 130x, (11) 130c, (12) 130h, (13) 130b, (14) 130m, (15) 130r, (16) 130w, (17) 130g, (18) 130L, (19) 130q, (20) 130v, (21) 130a, (22) 130f, (23) 130k, (24) 130p, (25) 130u.

In some embodiments, the positions of candidate indicators 536 (e.g., the order in which candidate indicators 536 are arranged) may depend on the rankings associated with the recruiting categories to which the candidates are assigned. For example, the candidate indicators 536 may be arranged in an order (e.g., left-to-right, right-to-left, top-to-bottom, or bottom-to-top) such that candidate indicators corresponding to candidates assigned to a higher-ranked recruiting category are arranged earlier in the ordering than candidate indicators corresponding to candidates assigned to a lower-ranked recruiting category. In the example of FIG. 6, the candidate indicators 536 are arranged in order from left-to-right, and candidate indicators 536a, 536b, 536c, 536d, and 536e correspond to candidates assigned, respectively, to the second-ranked recruiting category (see recruiting category indicator 130j in FIG. 2), the third-ranked recruiting category (see recruiting category indicator 130d in FIG. 2), the fourth-ranked recruiting category (see recruiting category indicator 130o in FIG. 2), the twelfth-ranked recruiting category (see recruiting category indicator 130h in FIG. 2), and the fourteenth ranked recruiting category (see recruiting category indicator 130m in FIG. 2).

In some embodiments, the positions of candidate indicators 536 (e.g., the order in which candidate indicators 536 are arranged) may depend on the attribute scores and/or parameter values associated with the corresponding candidates. In some embodiments, when two or more candidates are assigned to the same recruiting category, the positions of the corresponding candidate indicators relative to each other may be determined based, at least in part, on the candidates' attribute scores and/or parameter values. For example, the ordering of candidate indicators corresponding to candidates from the same recruiting category may be depend on summary values associated with the candidates. In some embodiments, the summary value may be 0.5*(AES+APS), where AES is the candidate's average score for the “experience” attribute and APS is the candidate's average score for the “potential” attribute. In some embodiments, the summary value may be any suitable function of the candidate's attribute scores and/or parameter values, including but not limited to any suitable function of the attribute scores and/or parameter values used to assign the candidates to the recruiting categories.

In some embodiments, candidate portion 502 may include a candidate indicator 538 corresponding to a target candidate. The target candidate may be an actual person or a model of a suitable candidate. Target scores for candidate attributes and/or values for candidate parameters may be associated with the target candidate.

In some embodiments, candidate portion 502 may include a candidate information section 550. In some embodiments, candidate information section 550 may include information corresponding to candidates, including, but not limited to, information corresponding to the candidates whose candidate indicators are included in candidate portion 502. In some embodiments, candidate information section 550 may include information corresponding to one or more attributes of the candidates. In some embodiments, candidate information section 550 may be organized in rows corresponding to candidate attributes and columns corresponding to candidates, or vice versa. In the example of FIG. 6, the columns of candidate information section 550 correspond to candidates, and the rows correspond to candidate attributes. In particular, in the example of FIG. 6, rows 551-553 include information relating to, respectively, the candidates' average scores for the “experience” attribute, the candidates' average scores for the “potential” attribute, and the candidates' scores for the “cultural fit” attribute. As can be seen in FIG. 6, candidate information section 550 may include information relating to the candidates' pre-assessment scores (e.g., scores based on the candidates' resumes), the candidates' locations (e.g., places of residence), the sources through which the candidates were identified as hiring candidates, and/or the candidates' current employers.

In some embodiments, user interface 500 may include an assessment portion 570. Assessment portion 570 may identify one or more sources of assessments of a candidate (e.g., people who interviewed the candidate, people who screened the candidate's application, etc.), and the attribute scores assigned to the candidate by the one or more assessment sources.

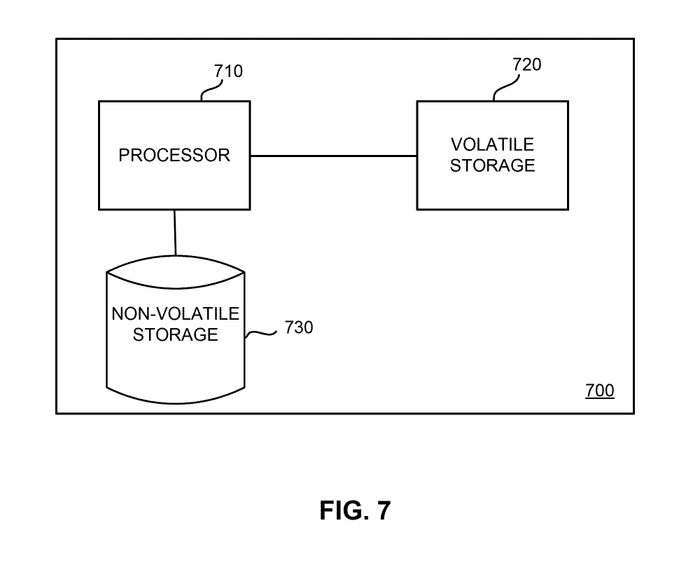

A system with applicability to evaluation of hiring candidates in accordance with the techniques described herein may take any suitable form, as aspects of the present invention are not limited in this respect. An illustrative implementation of a computer system 700 that may be used in connection with some embodiments of the present invention is shown in FIG. 7. One or more computer systems such as computer system 700 may be used to implement any of the functionality described above. The computer system 700 may include one or more processors 710 and one or more computer-readable storage media (i.e., tangible, non-transitory computer-readable media), e.g., volatile storage 720 and one or more non-volatile storage media 730, which may be formed of any suitable non-volatile data storage media. The processor 710 may control writing data to and reading data from the volatile storage 720 and/or the non-volatile storage device 730 in any suitable manner, as aspects of the present invention are not limited in this respect. To perform any of the functionality described herein, processor 710 may execute one or more instructions stored in one or more computer-readable storage media (e.g., volatile storage 720), which may serve as tangible, non-transitory computer-readable media storing instructions for execution by processor 710.

In some embodiments, one or more processors 710 may include one or more processing circuits, including, but not limited to, a central processing unit (CPU), a graphics processing unit (GPU), a field-programmable gate array (FPGA), an accelerator, and/or any other suitable device (e.g., circuit) configured to process data.

It should be appreciated from the foregoing that one embodiment of the invention is directed to a method 600 having applicability to evaluation of hiring candidates, as illustrated in FIG. 1. Method 600 may be performed, for example, by one or more components of a computer system 700, although other implementations are possible, as method 600 is not limited in this respect.

It should be appreciated that embodiments are not limited to evaluation of hiring candidates. In some embodiments, the methods and apparatus described herein may have applicability to evaluation of candidates other than hiring candidates. In some embodiments, the techniques described herein may be applied to evaluate candidates for membership or inclusion in any group or organization, including, but not limited to, a fraternity, a sorority, an honor society, a charitable organization, an athletic team, a private club, etc. In some embodiments, the techniques described herein may be applied to evaluate candidates for political office, candidates for promotion within an organization, and/or any other suitable candidates.

It should be appreciated that user interfaces and elements of user interfaces, including, but not limited to “indicators” (e.g., recruiting category indicators, candidate indicators, and/or interest level indicators), are not limited to visual user interfaces, in accordance with some embodiments. Any other suitable interface, including, but not limited to, an audio interface (e.g., an audio speaker) or a haptic interface may be used to present an element of a user interface (e.g., an indicator) to a user. For example, an interest level indicator may be presented by playing or synthesizing a sound, such that a property of the sound (e.g., pitch, volume, etc.) indicates a recommended level of interest in a candidate.

In the examples of FIGS. 2, 4, and 5, a recommendation indicator is illustrated using an image of one or more coins. It should be appreciated that a recommendation indicator may indicate a recommendation that relates to a candidate's compensation or any other suitable recommendation, as described above. In addition, it should be appreciated that a recommendation indicator may include an image of a coin and/or any other suitable image.

The above-described embodiments of the present invention can be implemented in any of numerous ways. For example, the embodiments may be implemented using hardware, software or a combination thereof. When implemented in software, the software code can be executed on any suitable processor (e.g., processing circuit) or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one computer-readable storage medium (i.e., at least one tangible, non-transitory computer-readable medium, e.g., a computer memory, a floppy disk, a compact disk, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method comprising:
using computer-encoded data representing scores associated with a hiring candidate, determining a first score for a first attribute of the hiring candidate and a second score for a second attribute of the hiring candidate;
using one or more processing circuits, assigning the hiring candidate to a recruiting category based, at least in part, on the first and second scores; and
controlling a display device to display an indicator associated with the hiring candidate, wherein a property of the indicator is based, at least in part, on the recruiting category to which the hiring candidate is assigned.

2. The method of claim 1, wherein displaying an indicator associated with the hiring candidate comprises displaying the indicator associated with the hiring candidate in a region of a graph, the region being determined based, at least in part, on the recruiting category to which the hiring candidate is assigned.

3. The method of claim 2, wherein displaying the indicator associated with the hiring candidate in a region of a graph comprises displaying the indicator associated with the hiring candidate at a position in the region of the graph, the position being determined based, at least in part, on the first and second scores for the respective first and second attributes of the hiring candidate.

4. The method of claim 2, wherein the graph includes a first axis corresponding to the first attribute and a second axis corresponding to the second attribute, and wherein the region of the graph corresponds to a first portion of the first axis and a second portion of the second axis, wherein the first portion of the first axis is associated with the first score for the first attribute of the hiring candidate, and wherein the second portion of the second axis is associated with the second score for the second attribute of the hiring candidate.

5. The method of claim 2, further comprising displaying a plurality of category indicators corresponding to a respective plurality of recruiting categories, wherein:
the plurality of recruiting categories includes the recruiting category to which the hiring candidate is assigned,
the plurality of category indicators includes a category indicator corresponding to the recruiting category to which the hiring candidate is assigned, and
at least a portion of the indicator associated with the hiring candidate coincides with at least a portion of the category indicator corresponding to the recruiting category to which the hiring candidate is assigned.

6. The method of claim 5, wherein displaying the plurality of category indicators corresponding to the respective plurality of recruiting categories comprises displaying the plurality of category indicators arranged in a grid.

7. The method of claim 5, wherein the category indicator corresponding to the recruiting category to which the hiring candidate is assigned includes a shade of a color, and wherein the color and/or shade indicates a level of interest in the hiring candidate.

8. The method of claim 5, further comprising:
in response to selection of the category indicator corresponding to the recruiting category to which the hiring candidate is assigned, displaying information identifying and/or characterizing one or more hiring candidates assigned to the recruiting category, the one or more hiring candidates including the hiring candidate.

9. The method of claim 1, wherein displaying an indicator associated with the hiring candidate comprises displaying the indicator associated with the hiring candidate in an ordered list of indicators associated with respective hiring candidates, and wherein a position of the indicator in the ordered list of indicators is based, at least in part, on the recruiting category to which the hiring candidate is assigned.

10. The method of claim 1, wherein the recruiting category corresponds to a first range of scores for the first attribute and to a second range of scores for the second attribute, and wherein assigning the candidate to the recruiting category based, at least in part, on the first and second scores comprises selecting the recruiting category from a plurality of recruiting categories based, at least in part, on the first range of scores including the first score for the first attribute of the hiring candidate and on the second range of scores including the second score for the second attribute of the hiring candidate.

11. The method of claim 1, wherein determining the first score comprises determining a mean, median, mode, standard deviation, and/or variance of a set of scores for the first attribute of the hiring candidate.

12. The method of claim 1, further comprising determining and presenting a recommendation based, at least in part, on the recruiting category, wherein the recommendation comprises a recommendation of whether to extend a hiring offer to the hiring candidate, a recommendation of whether to extend an interview offer to the hiring candidate, and/or a recommendation of an amount of compensation to offer the hiring candidate.

13. The method of claim 1, wherein displaying the indicator associated with the hiring candidate comprises displaying a count of a number of hiring candidates assigned to the recruiting category to which the hiring candidate is assigned.

14. The method of claim 13, wherein displaying the indicator associated with the hiring candidate comprises displaying information identifying and/or characterizing the hiring candidate.

15. An apparatus comprising:
at least one processing circuit; and
at least one storage medium storing instructions that, when executed by the at least one processing circuit, cause the at least one processing circuit to:
determine a first score and a second score for respective first and second attributes of a hiring candidate based, at least in part, on scores associated with the hiring candidate,
assign the hiring candidate to a recruiting category based, at least in part, on the first and second scores, and
control a display device to display an indicator associated with the hiring candidate, wherein a property of the indicator is based, at least in part, on the recruiting category to which the hiring candidate is assigned.

16. The apparatus of claim 15, wherein displaying an indicator associated with the hiring candidate comprises displaying the indicator associated with the hiring candidate in a region of a graph, the region being determined based, at least in part, on the recruiting category to which the hiring candidate is assigned.

17. The apparatus of claim 15, wherein displaying an indicator associated with the hiring candidate comprises displaying the indicator associated with the hiring candidate in an ordered list of indicators associated with respective hiring candidates, and wherein a position of the indicator in the ordered list of indicators is based, at least in part, on the recruiting category to which the hiring candidate is assigned.

18. At least one computer-readable storage medium encoded with computer-executable instructions that, when executed, perform a method comprising:
using computer-encoded data representing scores associated with a hiring candidate, determining a first score for a first attribute of the hiring candidate and a second score for a second attribute of the hiring candidate;
using one or more processing circuits, assigning the hiring candidate to a recruiting category based, at least in part, on the first and second scores; and
controlling a display device to display an indicator associated with the hiring candidate, wherein a property of the indicator is based, at least in part, on the recruiting category to which the hiring candidate is assigned.

19. The at least one computer-readable storage medium of claim 18, wherein displaying an indicator associated with the hiring candidate comprises displaying the indicator associated with the hiring candidate in a region of a graph, the region being determined based, at least in part, on the recruiting category to which the hiring candidate is assigned.

20. The at least one computer-readable storage medium of claim 18, wherein displaying an indicator associated with the hiring candidate comprises displaying the indicator associated with the hiring candidate in an ordered list of indicators associated with respective hiring candidates, and wherein a position of the indicator in the ordered list of indicators is based, at least in part, on the recruiting category to which the hiring candidate is assigned.
